(19) United States
(12) Patent Application Publication
(10) Pub. No.: US 2014/0193037 A1
(43) Pub. Date: Jul. 10, 2014

(54) Displaying an Image on Multiple Dynamically Located Displays

(71) Applicants: John Fleck Stitzinger, State College, PA (US); David G. Grossman, Vienna, VA (US)

(72) Inventors: John Fleck Stitzinger, State College, PA (US); David G. Grossman, Vienna, VA (US)

(21) Appl. No.: 14/147,527

(22) Filed: Jan. 4, 2014

Related U.S. Application Data
(60) Provisional application No. 61/749,978, filed on Jan. 8, 2013.

(51) Int. Cl. G09G 5/12; G06T 7/00

(52) U.S. Cl. CPC G09G 5/12; G06T 7/004
USPC 382/103

(57) ABSTRACT

Moving and/or still image(s) are aligned to multiple display devices. One or more display devices may be connected to a system using a variety of communicative connections. One or more imaging devices may be used to capture images of a plurality of display devices while the display devices display one or more unique identifiers. The captured image(s) are processed to determine the location of one or more of the connected display devices. Portions of an overall image may be distributed to one or more of the connected display devices to display the overall image across the display device(s). Location information for one or more display devices may be updated periodically, which may update the portion of an image displayed on one or more connected display devices.

### CROSS REFERENCE TO RELATED APPLICATIONS

This application claims the benefit of U.S. Provisional Patent Application No. 61/749978, filed Jan. 8, 2013, entitled “Image Alignment to Multiple Display Devices,” which is hereby incorporated by reference in its entirety.

### BRIEF DESCRIPTION OF THE SEVERAL VIEWS OF THE DRAWINGS

FIG. 1 is an example flow diagram of determining the location of one or more connected display devices according to an embodiment of the present invention.

FIG. 2 is an example flow diagram of determining the location of one or more connected display devices and displaying a corresponding portion of an image on each of the one or more connected display devices according to an embodiment of the present invention.

FIG. 3 is an example flow diagram of updating the location of one or more connected devices and displaying a corresponding portion of an image on each of the one or more connected devices based on an updated location according to an embodiment of the present invention.

FIG. 4 is an example block diagram of a system for determining the location of one or more connected display devices and transmitting data to each of the one or more connected display devices according to an embodiment of the present invention.

FIG. 5 is an example block diagram of a system for determining the location of one or more connected display devices using multiple imaging devices and transmitting data to each of the one or more connected display devices according to an embodiment of the present invention.

FIG. 6A through FIG. 6D are example diagrams showing a portion of an image displayed on a single connected display device according to an embodiment of the present invention.

FIG. 7A through FIG. 7D are example diagrams showing a portion of an image displayed on one or more connected display devices according to an embodiment of the present invention.

FIG. 8A through 8G are example diagrams showing various unique identifiers displayed on a connected display device according to an embodiment of the present invention.

### DETAILED DESCRIPTION OF EMBODIMENTS

Embodiments of the present invention determine the relative location of one or more display devices and align portions of an image to each of the one or more display devices to form a large-scale ad-hoc integrated or unified display. Embodiments of a system for aligning multiple display devices to an image may employ data input from one or more imaging devices to determine the location of one or more connected display devices and determine the portion of an image to display on each of the one or more connected display devices. A system may periodically check the location of one or more connected devices to determine if a device has changed location. If it is determined that a device has changed location, a system may remap the location of the connected display devices and cause an updated portion of an image to be displayed on one or more of the connected devices.

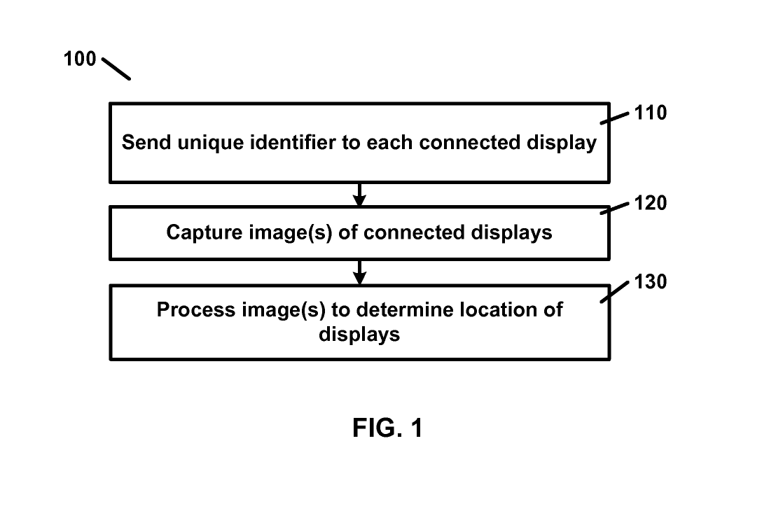

Referring to FIG. 1, an example embodiment 100 to determine the location of one or more connected display devices is illustrated. One or more display devices may be connectively coupled to a system for aligning multiple display devices to an image. At block 110, a system may transmit a unique identifier for each display and cause the transmitted unique identifier(s) to be displayed on their respective connected display devices. In some embodiments, each unique identifier may be randomly generated. In other embodiments, each unique identifier may be generated iteratively. In still further embodiments, each unique identifier may be based on the network address of each of the one or more connected display devices. However, it may be recognized that a unique identifier generated, transmitted, and caused to be displayed at block 110 may be generated in various manners. Additionally, a unique identifier transmitted at block 110 may further contain one or more registration points or marks to be displayed on one or more connected display devices. According to some of the various embodiments, a unique identifier may be spread over one or more of the plurality of display devices to narrow a range of displays for subsequent unique identifiers in a temporal sequence of unique identifiers being displayed on connected display devices.

At block 120, one or more images of an area having one or more connected display devices may be captured. One or more of the display devices may receive instructions at block 110 to display a unique identifier on one or more connected display devices. In some embodiments, an imaging device may capture a single image at block 120. In other embodiments, an imaging device may capture a plurality of images at block 120. By way of example, in an embodiment utilizing the capture of multiple images at block 120, the brightness of one or more connected display devices may be attenuated, and an image may be captured for connected display device(s). This attenuation may be used as a unique identifier. Attenuation of all or part of a screen's brightness may cause all or part of the connected display to be brighter or dimmer than other connected display devices. For example, the size and/or intensity of a display area may be attenuated by 10 to 30 percent or by any other amount (e.g., between 0 to 100 percent). In some embodiments, the attenuation may be set to be more perceptible by an imaging device than a human. This could be accomplished by attenuating an area for a brief period of time, for example, less than 0.05 seconds, to be captured by an imaging device employing an effective capture rate that is greater than 1/20th of a second.

The one or more images of the connected display devices may be captured at block 120 and may be processed at block 130 to determine the location of one or more of the connected display devices. In an embodiment, at block 130, a set of coordinates on a two or three-dimensional plane may be assigned to one or more of the connected display devices. In some embodiments, at block 130, location information may be received from one or more of the connected display devices. Additional location information from connected display device(s) may comprise seat location information (e.g. for use in a stadium or arena environment), latitude-longitude information, other location information, a combination thereof, and/or the like.

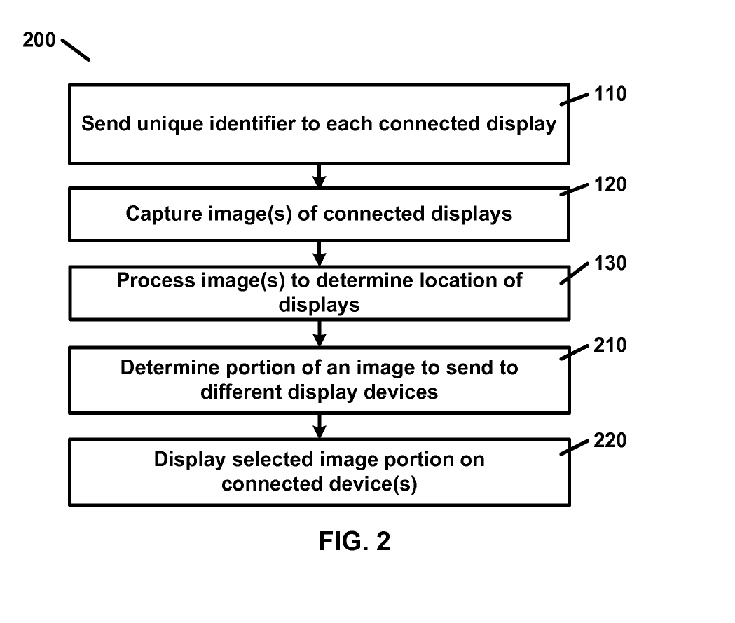

Referring now to FIG. 2, an example embodiment of displaying an image on multiple display devices 200 is disclosed. Block 130 may determine the location of each of one or more connected devices. A portion of an image to be displayed on one or more connected display devices may be determined at block 210. In some embodiments, block 210 may display an approximately equal portion of an overall image on each of one or more connected display devices. In other embodiments, block 210 may receive display size information from block 120 (e.g. from the positioning of registration marks on each connected display device). Block 210 may use display size information received from processing one or more images captured at block 120 to determine a portion of an overall image corresponding to the size and position of one or more of the connected display devices to be displayed by one or more of the connected display devices. At block 220, one or more of the connected display devices may display a portion of an overall image determined at block 210.

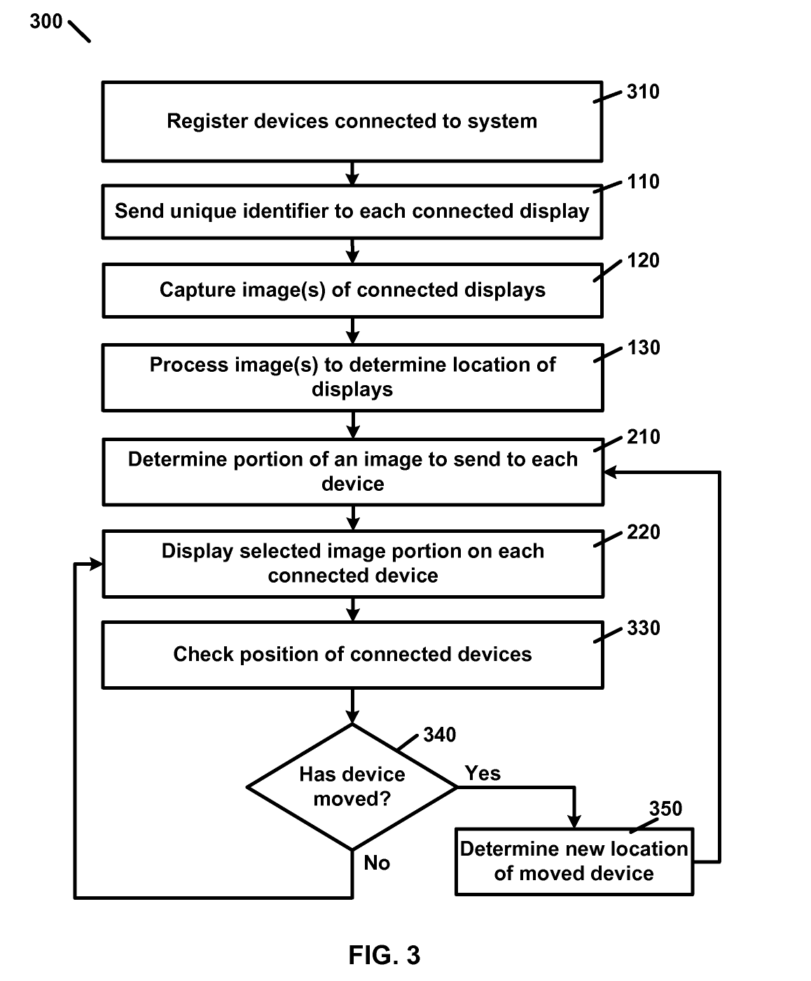

Now referring to FIG. 3, an example embodiment 300 to display an image on multiple display devices and change the portion of an image to be displayed when a connected display device moves locations is disclosed. At block 310, the presence of one or more connected display devices to display an image using multiple display devices may be registered. An initial image portion of an image may have been caused to be displayed on a connected display device at block 220. A position check may be performed for one or more connected display devices at block 330. In an embodiment, at block 330, at least one image of the one or more connected display devices may be captured and the position of one or more of the connected devices may be determined based on one or more of the captured images. In some embodiments, the one or more images captured at block 330 may be supplemented by location information provided by one or more of the connected display devices. For example, each of the one or more connected display devices may continually or periodically transmit latitude and longitude information to a processing system. Position information generated at block 330 may be employed at block 340 to compare the previously known position of one or more connected display devices to the current location of the one or more connected display devices determined at block 330. At block 340, if it is determined that a connected display device has moved, a new position may be determined at block 350 for one or more connected display devices that was determined to be in a different position. At block 210, the portion of an overall image to be displayed on one or more of the connected display devices may be updated. If at block 340, it is determined that a connected display device has not moved, the already stored location information may be employed to determine the portion of the image to send to one or more of the connected devices that have been determined to have remained stationary at block 220.

As per some embodiments of the present invention, additional actions may be taken to ensure an overall image to be displayed on one or more of the connected display devices is displayed as desired. Imaging device(s) may reimage display device(s) and/or parts of a display area that are displaying an overall image. One or more known image processing techniques (e.g. the Canny edge-detection algorithm, the Sobel edge-detection algorithm, the Harris & Stephens/Plessey corner detection algorithm, the Moravec corner detection algorithm, the smallest univalue segment assimilating nucleus (SUSAN) corner detection algorithm, the Level curve curvature algorithm, a Laplacian of Gaussian algorithm, the Difference of Gaussian algorithm, the Determinant of Hessian algorithm, the maximally stable extremal regions (MSER) algorithm, the principal curvature-based region (PCBR) algorithm, the grey-level algorithm, and/or the like) may be employed to compare the displayed image(s) with the actual overall image. If the overall image is displayed properly, participating display devices and/or parts of a display area may be reimaged in a loop fashion. The loop may be completed even if an error is found. While this may be a continual process, reimaging may occur after delay (e.g., every 5 second, 30 second, 1 minute, 5 minutes, 30 minutes, 1 hour, 5 hours, 12 hours, 24 hours, and/or the like). If the overall image is not displayed properly, new section(s) of the overall display image for one or more of the display device(s) (and/or parts of a display area) may be resent to the affected display device(s). These actions may ensure an overall display image is properly displayed. These actions may also monitor the location and/or size of display devices and/or parts of a display area.

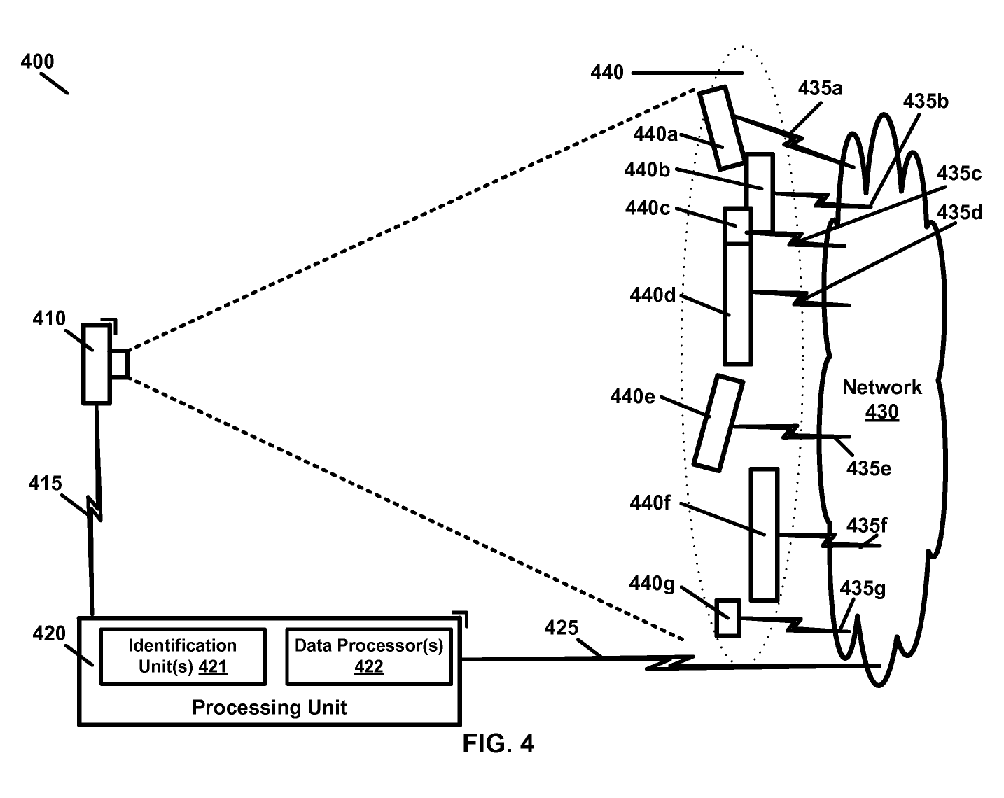

Referring now to FIG. 4, an embodiment of a system 400 to determine the location of multiple connected display devices and display portions of an overall image on one or more connected display devices is disclosed. System 400 may have imaging device(s) 410, a processing unit(s) 420, a network(s) 430, and one or more connected devices 440. Examples of connected devices 440 are illustrated in FIG. 4 with devices 440a through 440g, and examples of device network connections 435 between a connected device 440 and network(s) 430 are illustrated in FIG. 4 with device network connections 435a through 435g.

Imaging device(s) 410 may be connectively coupled to processing unit(s) 420 using a communications connection(s) 415. Imaging device(s) 410 may include one or more cameras, and may be configured to capture images displayed by display devices 440. In certain implementations, multiple imaging device(s) 410 may be used to capture display devices 440. Imaging device(s) 410 may additionally include 2D camera(s) and/or 3D camera(s), and may be configured to determine the distance to an object in the imaging device(s) 410 field of view, such as one or more display devices 440. This may be accomplished by, for example, determining the focal distance in which an object may be in focus, using a range finding technology such as laser or ultrasonic rangefinding, and/or from receiving and processing auxiliary data transmitted from one or more display devices, directly or through network 150. In some embodiments, imaging device(s) 410 may be connectively coupled to processing unit(s) 420 using wired serial connection(s) (e.g. devices using a Universal Serial Bus connection, an RS-232 connection, or similar), wired parallel connection(s), wired or wireless network connection(s), a combination thereof, and/or the like. In some embodiments, imaging device(s) 410 may contain additional location determining functionality or components. For example, imaging device(s) 410 may contain a range finding device, thermo-imaging device, stereoscopic imaging device, a combination thereof, and/or other functionality or components as appropriate and known in the art.

Processing unit(s) 420 may receive signals from imaging device(s) 410 and/or one or more display devices 440 for processing, and may further transmit image signals to one or more of display devices 440 for displaying. These image signals may be produced or generated in part or in whole from processing unit(s) 420, or may be produced or generated from other sources. Processing unit(s) 420 may include or comprise a server, a computer, a processor, a mobile device, a combination thereof, and/or the like. Processing unit(s) 420 may be integrated within one of imaging device(s) 410 and/or one or more of display device(s) 440a-440g. Processing unit(s) 420 may further be driven by computer-readable instructions stored on a non-transitory medium that instruct it to execute various tasks described herein.

Processing unit(s) 420 may have identification unit(s) 421 and data processor(s) 422. Identification unit(s) 421 may be configured to receive input from imaging device(s) 410 through communications connection(s) 415. In other embodiments, identification unit(s) 421 may be further configured to receive input from one or more connected display devices 440. Identification unit(s) 421 may be configured, for example, to accept input from one or more of the connected display devices 440 related to the location of one or more of the connected display devices, configuration (e.g. screen resolution) of one or more connected display devices, and/or any other appropriate input information as desired and known in the art. Data processor(s) 422 may be configured to receive input from identification unit(s) 421 to divide an overall display image into one or more portions corresponding to the location and configuration of one or more of the connected display devices 440. Processing unit(s) 420 may be connectively coupled to network(s) 430 through processing unit connection(s) 425, and one or more of the connected display devices 440 may be connectively coupled to network(s) 430 through one or more device network connections 435.

Network 430 may comprise one or more various communications technologies, such as the Internet, a local intranet, a cellular network, a Bluetooth network, an optical network, a NFC (Near field communication) network, an infrared network, a wireless network, a combination thereof, and/or the like. Network 430 may connect display devices 440, processing unit(s) 420, and/or imaging device(s) 410 directly, or it may connect one or more of these components through a bridge such as a Bluetooth or wireless link. Network(s) 430 may be personal area network(s), local area network(s), wide area network(s), other network(s) as appropriate and known in the art, a combination thereof, and/or the like. Processing unit connection(s) 425 and one or more device network connection(s) 435 may connect to network(s) 430 using device(s) compatible to one or more network communication standards. For example, processing unit connection(s) 425 and one or more device network connections 435 may employ wireless network communications (e.g. 802.11, Bluetooth, or similar), cellular network connections (e.g. networks operating on GSM, WCDMA, LTE, other cellular network technologies as appropriate and known in the art, a combination thereof, and/or the like), infrared data transfer, other network communications as known in the art, a combination thereof, and/or the like.

Some number of individual display devices such as devices 440a through 440g in the plurality of display devices 440 may be of different sizes and may overlap. The display devices 440 may be mounted co-planar to each other, such as on a wall or another planar surface, or they may be mounted on a series of surfaces that are not co-planar. Several of the display devices 440 may be tilted at an angle with respect to each other. Although FIG. 4 illustrates seven specific display devices 440a, 440b, 440c, 440d, 440e, 440f, and 440g, these are illustrative examples only and should not be construed as limiting the number of display devices in the plurality.

Display devices 440 may include computer monitors, mobile phones, tablets, televisions, LEDs, other display devices, a combination thereof, and/or the like. Individual display devices among the plurality of display devices 440 may each have a resolution of a plurality of pixels, or a single pixel, or the plurality 440 may comprise a combination of single pixel resolution display devices and multiple pixel resolution display devices.

One or more individual display devices 440a-440g may be remotely controlled or driven, such as with commands from the processing unit(s) 420 and/or imaging device(s) 410 through network 430. A display device may contain instructions for interacting with the processing unit 420 and/or network 430, such as receiving a unique identification pattern and/or displaying a representation of the unique identification pattern. Such instructions may be stored in a non-transitory medium of the display device, and may be downloadable as an executable “app” or application, such as from processing unit 420, imaging device 410, and/or an external server, or may pre-exist in one or more of display device(s) 440, such as in firmware or a pre-installed application. A set of instructions may be valid for a limited time or a specific area, or may be retainable or storable on a display device for repeated use with multiple instances of processing unit(s) 420, network 430, and/or imaging device(s) 410.

One or more individual display devices may able to transmit auxiliary information, such as device manufacturer name, device display size, device pixel resolution, device configuration information, GPS information, a combination thereof, and/or the like. A display device may, for example, transmit such auxiliary information to processing unit(s) 420 and/or imaging device(s) 410 through network 430, may transmit such auxiliary information as an Infrared signal to imaging device(s) 410, or may transmit such auxiliary information as an embedded or steganographic signal in its display output.

Some or all of the participating display device(s) may send device specific information to the processing unit(s) 420. Device specific information may include, for example, the type of display device and/or parts of a display area, the size of the display device and/or parts of a display area, the coordinates of a display device and/or parts of a display area (e.g., the coordinates as determined by the Global Positioning System (GPS), Russian Global Navigation Satellite System (GLONASS), Galileo Positioning System, BeiDou Satellite Navigation System (COMPASS), Indian Regional navigational Satellite System, and/or the like), and/or the like.

Processing unit(s) 420 may contain and/or be associated with memory to store the location and/or size information for display device(s) and/or parts of a display area. Optionally, this memory or additional memory may also store the identifying information. The identifying information, the size, and/or location of the display devices and/or parts of a display area may be stored in a lookup table or a series of lookup tables. Alternatively, the identifying information that may be pushed or otherwise sent to display device(s) and/or parts of a display area may be derived from information in the memory.

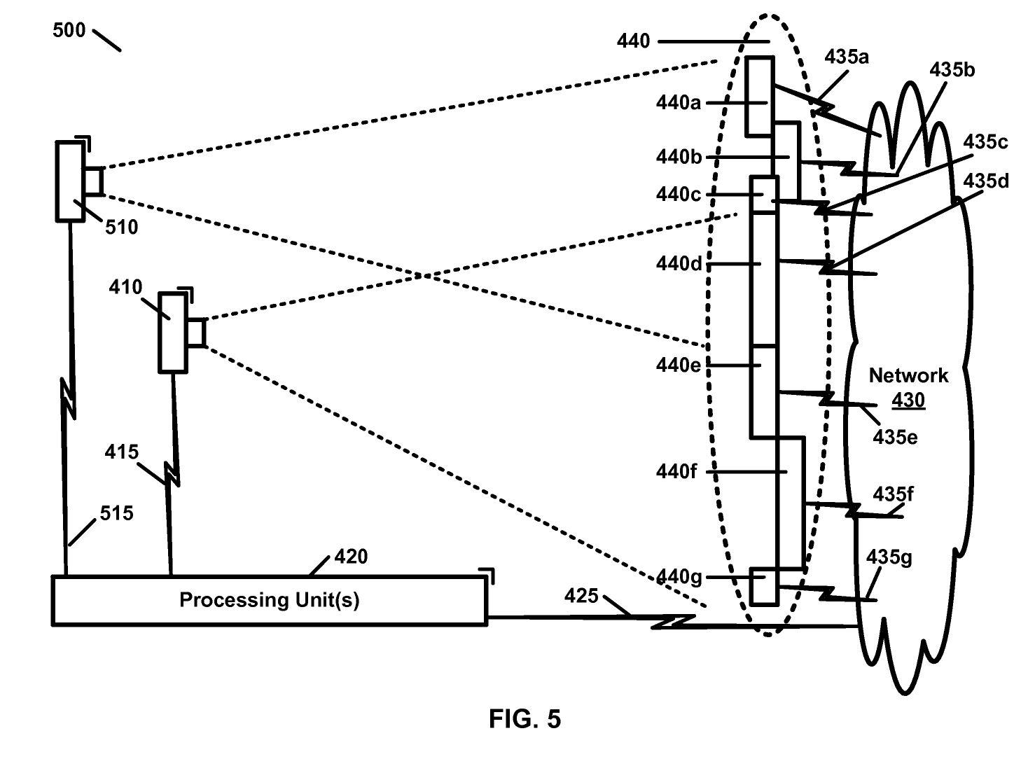

FIG. 5 illustrates an embodiment of a system 500 to determine the location of multiple connected display devices and display portions of multiple images of the one or more connected display devices. System 500 may have imaging device(s) 410 and 510, a processing unit(s) 420, a network(s) 430, and one or more connected devices 440. Imaging device(s) 410 and 510 may be connectively coupled to processing unit(s) 420 using a communications connection(s) 415 and 515 respectively. The imaging devices may produce multiple images that cover multiple fields of view. For example, imaging device 510 may generate image(s) that incorporate display devices 440a, 440b, 440c, and 440d in its field of view. Imaging device 510 may generate image(s) that incorporate display devices 440d a, 440e, 440f, and 440g in its field of view. The images may be processed by processing units(s) 420. In some of the various embodiments, the image(s) from imaging device(s) 510 and 410 may be processed by the same processing unit 420 and/or by multiple processing unit(s) 420. In yet other embodiments, the image(s) may be processed by the display devices themselves without a need from processing unit(s) 420. Some imaging device(s) 410 and/or 510 may have processing unit(s) 420 incorporated therein. Alternatively, processing unit(s) 420 may be discrete units. Processing unit(s) 420 may reside on a server. In yet other embodiments, processing unit(s) 420 may reside in one or more of the display device(s) 440. Distributing processing may increase the processing power of the system. Some processing units(s) 420 may combine processing from several sources such as imaging device 410 and/or 510, processing unit(s) 420, imaging device(s) 440, servers, and/or the like. When combining processing unit(s) 420, different processing unit(s) 420 may perform various functions. For example, an imaging device 410 may pre-process an image, or use imaging functions to identify possible targets. Another processing unit 420 may use this target information to combine images from multiple imaging device(s) 410. Display unit(s) 440 may be able to add specific location in formation for their own display device(s) 440. Together, this information may be used to generate location information for the collection of display device(s) 440.

Processing unit(s) 420 may use one or more known image processing techniques (e.g. the Canny edge-detection algorithm, the Sobel edge-detection algorithm, the Harris & Stephens/Plessey corner detection algorithm, the Moravec corner detection algorithm, the smallest univalue segment assimilating nucleus (SUSAN) corner detection algorithm, the Level curve curvature algorithm, a Laplacian of Gaussian algorithm, the Difference of Gaussian algorithm, the Determinant of Hessian algorithm, the maximally stable extremal regions (MSER) algorithm, the principal curvature-based region (PCBR) algorithm, the grey-level algorithm, and/or the like) to derive the location of the identifying information from the image. A person of skill in the art will recognize that the type of image processing technique used may largely depend on the type of identifying information displayed on the display device(s).

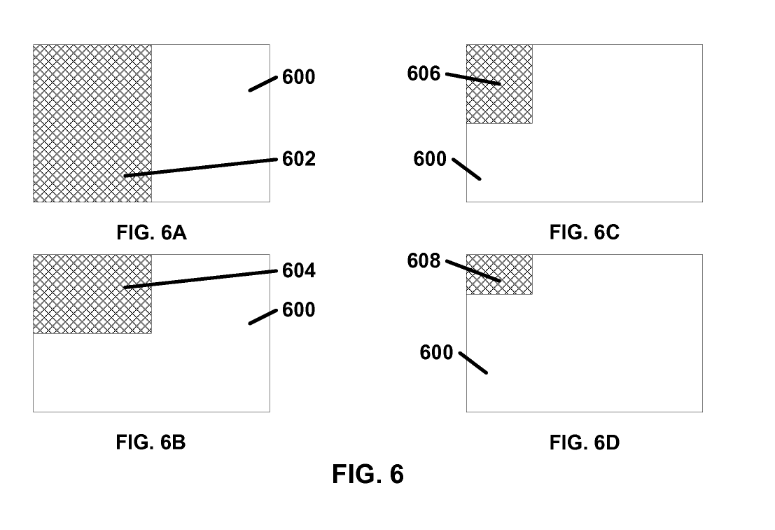

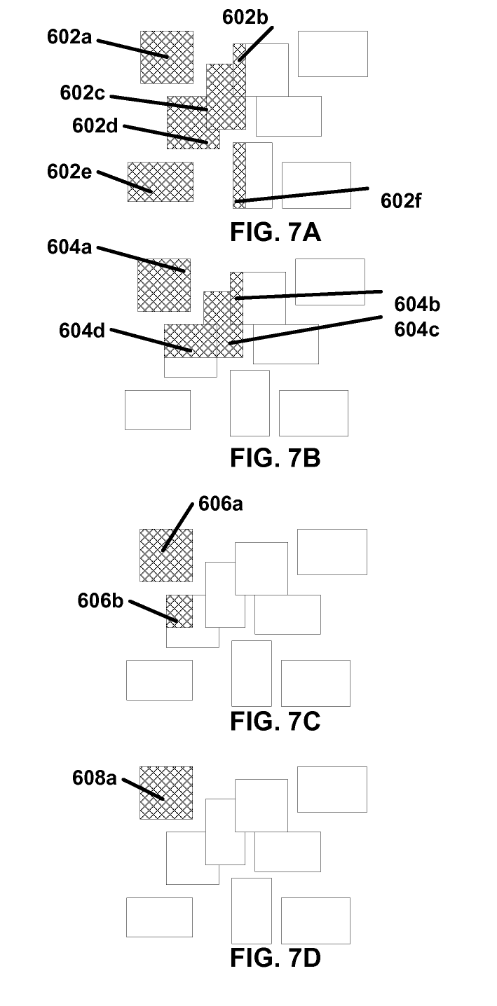

Referring now to FIG. 6 through FIG. 6D and FIG. 7A through FIG. 7D, embodiments of an image displayed on one or more connected devices is disclosed. FIG. 6A shows an image 602 occupying half of an overall display 600; FIG. 7A shows an embodiment of image 602 being distributed across a plurality of display devices. Some display devices may utilize the entire display to show a portion of an image, such as in display devices showing image portions 602a, 602c, 602d, and 602e. Other display devices may utilize a portion of a display to show a portion of an image, such as in display devices showing display portions 602b and 602f. FIG. 6B shows an image 604 occupying approximately one-quarter of an overall display 600; FIG. 7B shows an embodiment of image 604 being distributed across a plurality of display devices. Likewise, FIG. 6C shows an image 606 occupying approximately one-eighth of an overall display 600, distributed over images 606a and 606b in FIG. 7C. FIG. 6D shows an image 608 occupying approximately one-sixteenth of an overall display 600, distributed over image 608a in FIG. 7D.

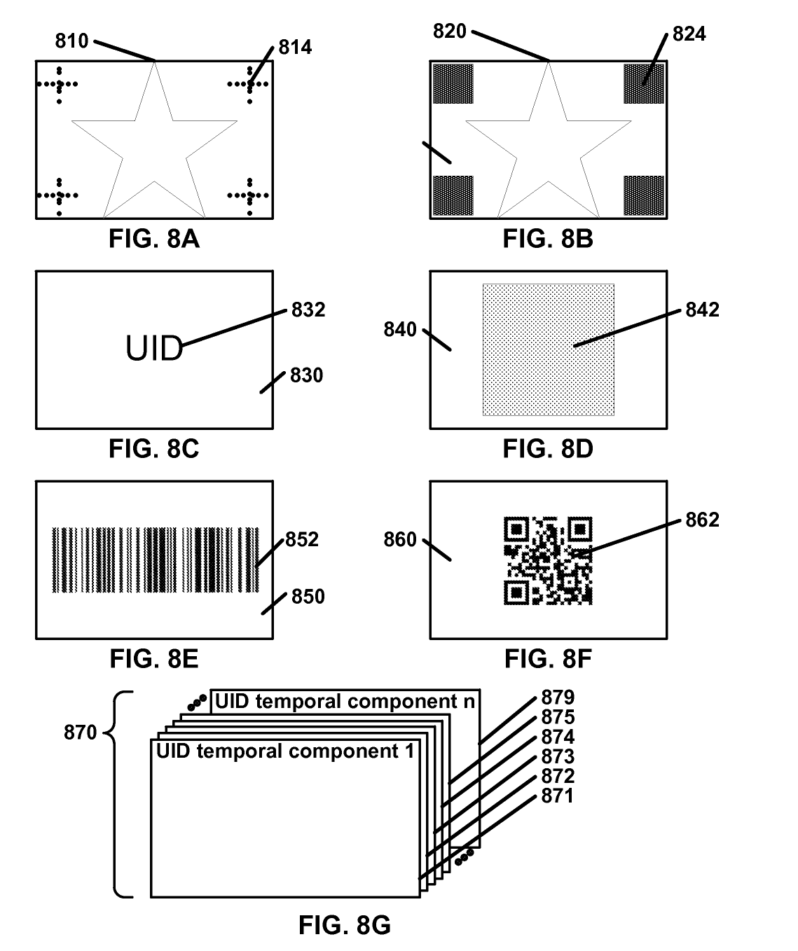

Referring now to FIG. 8A and FIG. 8B, embodiments of a unique identifier having a visual pattern and one or more registration marks are disclosed. Specifically, FIG. 8 shows an embodiment of a unique identifier 810 having one or more target-type registration marks 814. FIG. 8B shows an embodiment of a unique identifier 820 having one or more image-based registration marks 824. In some embodiments, registration marks 824 may be blocks of solid colors or other images. In other embodiments, registration marks 824 may also contain information in the form of a barcode, visual pattern, other information containers as appropriate and known in the art, a combination thereof, and/or the like. In some embodiments, unique identifier 810 and/or 820 may have a single registration mark such as registration marks 814 or 824. In other embodiments, unique identifier 810 and/or 820 may have a registration mark such as registration marks 814 or 824 in opposite corners (e.g. one in the upper-right corner and a corresponding mark in the lower-left corner, or similar). In still further embodiments, unique identifier 810 and/or 820 may have a registration mark 814 or 824 in each corner of an image. It may be recognized, however, that unique identifier 810 and/or 820 may have any number of registration marks as desired in various locations.

FIG. 8C through FIG. 8F illustrate various embodiments of a unique identifiers. FIG. 8C shows an embodiment of a unique identifier 830 displaying a readable unique identifier string 832. Readable unique identifier string 832 may be numeric, alphabetical, alphanumeric, and/or the like. In some embodiments, readable unique identifier string 832 may be generated by a processing system for determining the location of one or more connected display devices. In other embodiments, readable unique identifier string 832 may be independently generated on one or more of the connected display devices. By way of example, readable unique identifier strings 832 may be generated by one or more connected display devices using a connected display device's serial number, International Mobile Station Equipment (IMEI) number, Subscriber Identity Module (SIM) card serial number (ICCID), International Mobile Subscriber Identity (IMSI) number, other device-specific information as appropriate and known in the art, a combination thereof, and/or the like. FIG. 8D shows an embodiment of a unique identifier 840 displaying a unique image 842. Unique image 842 may be transmitted from a processing system or may be randomly chosen from a library of images stored on a connected display device. FIG. 8E shows an embodiment of a unique identifier 750 displaying a one-dimensional barcode 852. FIG. 8F shows an embodiment of a unique identifier 860 displaying a two-dimensional barcode 862. A two dimensional bar code may include a matrix bar code, a QR Code and/or the like. It may be recognized that one-dimensional barcode 852 and two-dimensional barcode 862 may be generated by a processing system, by a connected device, or be assigned based on a unique code associated with a particular user or connected display device.

FIG. 8G shows a unique identifier 870 with temporal components 871, 872, 873,874, 875 . . . 879. In these embodiments, the collection of temporal components 871, 872, 873,874, 875 . . . 879 together may comprise the unique identifier 870. Each of the temporal components 871, 872, 873,874, 875 . . . 879 may include any of the unique identifier (identification pattern) techniques discussed herein. However, with the temporal component, the unique identifier may include additional techniques, such as attenuating a particular area with a temporal pattern, display a detectable animation, modify the color and/or frequency of all or part of the identification pattern over time, display a temporal code (such as Morse code) visually, a combination thereof, and/or the like.

Some identification patterns may be less visibly noticeable than other identification patterns. For example, some identification patterns may include an infrared pattern, an attenuation pattern, or a watermarked, embedded, steganographic pattern inserted in the overall display pattern, a combination thereof, and/or the like. Other variations may include modifying the color and/or frequency of all or part of a pattern. The unique identifier pattern may be a spatial, temporal, or spatiotemporal pattern, a unique version of which may be transmitted to one or more of the display device(s).

Embodiments may determine the location of multiple display devices in a viewing field. A temporal and spatial pattern may be sent to each of the display devices. An imaging device such as a camera may view the multiple displays and determines their relative location based on what part of the pattern is displayed on each display device.

An overall display image may be divided into a multitude of display device specific images once the location of each display device is determined. This mechanism may be applied to identify the position of display devices in many different types of locations. For example, one or more of the display devices could be located anywhere within the field of view of one or more imaging devices. According to some of the various embodiments, one or more of the display devices could be located on roughly planar surface(s). In other embodiments, one or more of the display devices could be located on a curved surface. In yet other embodiments, one or more of the display devices could be located independently of any surface (e.g. attached to a stand, a poll, hanging from a ceiling). Those skilled in the art will recognize that displays may be located in combinations of the above, and/or the like.

According to some of the various embodiments, the display devices to be identified may be configured to generate an optical signal (visual or Infrared) on demand or periodically. The optical signals may include visual, infrared or other signals in an electromagnetic band. Display devices do not need to be identical. Display devices may not require any special hardware but may take advantage of custom hardware. Display devices may communicate with a service to be assigned functionality once their position has been determined.

For example, according to some of the various embodiments, an imaging device (such as a camera) may be pointed at the display devices from a distance. The maximum angle of the perpendicular of the planar average of the display devices to the camera location may depend on the resolution of the measuring camera and the unevenness of the display devices to the average plane of the display devices. The camera minimum resolution for any particular application may be affected by the vibration of the camera and the minimum distance expected between any 2 display devices as viewed from the camera. This may take into account the possible movement of the display devices to be located.

According to some of the various embodiments, imaging devices (such as cameras) may be used to capture images of the configuration of the multiple displays. Multiple imaging devices may be used to cover more objects. Imaging devices may include mobile phone cameras, digital handheld cameras; mounted cameras, video cameras, light field cameras, and/or the like. Imaging devices may be configured with a link to a processing system. Imaging device(s) (e.g. cameras) may include any electronic device that may create a digital 2D representation of a scene at a distance from the camera. Some embodiments may also include 3-D cameras. 3D cameras may include two 2D cameras that are positioned at a distance apart from each other. It is envisioned that other types of 3D or 2D cameras may be used. Some cameras may provide information of distance to an object. For example, some imaging devices may be remotely focused and provide range information on a focused object. Other imaging devices may have or be used with a range finding technology such as a laser range finder, ultrasonic rangefinder, etc. Another example of an imaging device is a light field camera. A light-field camera, also called a plenoptic camera, is a camera that uses a microlens array to capture 4D light field information about a scene. Such light field information may be used to improve the solution of computer graphics and computer vision-related problems, and to make digital plenoptic pictures that can be refocused after they are taken. A light field camera may be obtained from Lytro, Inc. of Mountain View, Calif.

According to various embodiments, numerous display devices and configurations may be employed. A series of display devices mounted on a wall or planar surface. Display devices may be of different sizes. Display devices may overlap. Some display devices may be titled at an angle, in which case a module may be employed to rotate the display signal for that display device. Display devices may also be mounted on a series of surfaces that are not planar. Position patterns may be adjusted to determine the relative distance of each display device from a viewing location. Module(s) may be employed to adjust the size of the displayed signal to each display device based on its location. Display devices may include computer monitors, cell phones, tablets, televisions, lamps, or other display devices (e.g. discrete and/or arrayed LED's; controllable lights on a string). Using remote controlled switches, the display pixels could be house and street lights for viewing from above such as an airplane or satellite. Display devices may be driven with instructions from the processing system. Some displays may self-report their size. For example, a computer device driver may receive a signal from a display device indicating the manufacturer of the display device, the size of the display device and the pixel capability of the display device as well as possible configurations of the display device. Some display devices may have a position capability such as GPS. To the extent that these capabilities have adequate resolution, they may be used in combination with the patterns to locate the display devices.

Various processing systems may be employed according to the various embodiments. A processing system may receive signals from imaging devices. Signals from imaging devices may be processed by other processing devices such as computers, and/or phones, as well as camera devices themselves with information ultimately being sent to the processing system. Data may be transmitted to displays. The data to individual displays may be processed by other processing devices such as computers, and/or phones, as well as the display devices themselves with information ultimately originating from the processing system. The processing system may include a server, a computer, a mobile device, a camera, a display device, a combination thereof and/or the like.

Cameras, display devices, processing systems, and intermediate processing systems may communicate over network(s) such as the Internet, intranets, cellular network(s), Wi-Fi network(s), wireless network(s), wireless local area network(s), wireless personal area network(s), wireless mesh network(s), a line-of-sight wireless connection(s), combinations thereof, and/or the like. Cameras, display devices, processing systems, and intermediate processing systems may communicate to each other via communication technologies such as light, Wi-Fi, Bluetooth, NFC (Near field communication devices), Infrared, combinations thereof, and/or the like. Devices may use other devices as a bridge when communicating. For example, a tablet display device may communicate via Bluetooth or Wi-Fi to another tablet that has a cellular data connection to a network.

According to the various embodiments, location patterns may be generated in different ways. The processing system may direct the presentation of location patterns. Some patterns (or parts thereof) may be generated by the processing system. Some patterns (or parts thereof) may be generated by other devices such as computers, phones, the display devices themselves, etc.

According to some of the various embodiments, location patterns may change with time. Example location patterns may include a unique identifier pattern that may be sent to each display device. Other example location patterns may include an attenuation pattern. Yet another example patter may include a rotating binary pattern. A rotating binary pattern may make half the pattern image unique (e.g. black, stripped, attenuated, and/or the like) and the other half of the pattern image unique (e.g. white, solid, amplified, and/or the like) indicating to the system where a subset of the display devices are located. This pattern may be run iteratively until the location of each display device is known.

In some cases, a pattern may be overlaid on a regular image, where each pixel (or group of pixels are modified with an identifiable pattern. For example, some pixels may be attenuated by 10 to 30 percent for short periods of time (attenuation pattern). As this pattern moves around the image, the location of each display device may be determined. Another example may include displaying test pattern(s) (like a puzzle) used to locate each display device. Some example patterns may be used to determine the size of a display device. For example, once a display device is located, a special pattern may be moved or displayed on the display device to determine its relative size against the overall display configuration. Patterns may be used to determine how many effective pixels are available on the display device.

Pattern(s) may be split into initial location patterns and update patterns. Some patterns may come from (or be derived from) lookup tables. Some patterns may be dynamically generated. Once the size of a display is known, a simpler pattern may be employed to locate the display device (e.g. a cross hair at a known location on the display, positional registration marks, a positioned logo, attenuation patterns, a combination thereof, and/or the like).

Patterns may be employed multiple ways to locate the position(s) of display(s). For example, one technique to find the position of N display devices may include: for each display device determine and display a pattern based on an M bit unique Identifier (UID). Some systems may synchronize the broadcast of UID's using a using a global Real Time Clock (e.g. Time of day on Cellular device, or GPS). Some systems may determine if there are display devices not participating in the system in the viewing area. For example, on intervals, a pattern may be sent by participating display devices. UID's may be of various sizes such as 28 bits, 30 bits etc. The size of the UID may be determined to allow different numbers of display devices to participate. Imaging device(s) may capture image(s) of the viewing area for use in identifying the participating display devices. UID's of participating display devices in the captured image(s) may be sent to a server for decoding or may be decoded by the imaging device internally. The received UID's may be correlated with each device and its location (e.g. feet from defined origin or predefined zone possibly seat number in an auditorium).

In some of the various embodiments, display device(s) may join a network on an ad hoc basis. For example, a display device such as a smart phone and/or tablet may go to one of numerous network locations that are in communication with and/or are part of the overall display system. At this network location, the display device may obtain a pattern to display or register their own pattern to be used in identifying their location and joining them into the display system.

Various techniques may be employed for detecting display device(s) as their position changes. For example, if display device(s) can emit Infrared light, the infrared light may be used to continually send an ID for imaging device(s) to monitor and for the system to take action if any display devices move from their determined position. In another example, if display device(s) can only emit visible light, the imaging device(s) may monitor display devices for any that may be missing from their expected location. In yet another example, the overall displayed image may be monitored for anomalies. Similarly, a pattern may be embedded in a presentation image to determine when an anomaly occurs (e.g. attenuation pattern).

Embodiments of the present invention may be used in numerous applications. For example, embodiments may be employed to identify the location of objects on a dance floor. Embodiments may be employed to identify display devices placed on a surface to create a larger display. Some embodiments may be employed as part of custom signage applications. Embodiments may be employed to identify and use hand held devices such as cell phones and/or tablets to create a high resolution display out of an array of lower resolution devices. Multiple display devices in an auditorium or stadium may be combined using embodiments to generate a large display.

The disclosed system may be implemented as a series of applications to run on individual display devices (e.g. smart Phone, tablet, portable computers) through a web based service. Displayed images across the multiple display devices may be static or dynamic.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on examples of processes and systems using analysis of one or more images of an area of devices to be mapped to determine the location of one or more connected devices and align portions of an image to the location of one or more connected devices determined from image analysis. However, one skilled in the art will recognize that embodiments of the invention could align portions of an image to one or more connected devices using, for example, multiple data inputs or continuous image processing from a motion imaging device. Further, one skilled in the art will recognize that embodiments of the invention could utilize personal area network connections between connected devices to aid in determining the location of one or more connected devices in addition to other location information, such as seat location or latitude-longitude data, that may be transmitted to a system to aid in processing one or more images to determine the location of one or more connected display devices.

Aspects of the present invention are disclosed in the foregoing description and related figures directed to specific embodiments of the invention. Those skilled in the art will recognize that alternate embodiments may be devised without departing from the spirit or the scope of the claims. In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, wetware (i.e. hardware with a biological element) or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that conFIG. Connections between internal hardware modules with lesser functionality on a programmable device. Finally, it needs to be emphasized that the above mentioned technologies may be used in combination to achieve the result of a functional module.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer program product for locating display devices, the computer program product comprising a computer readable storage medium having program code embodied therewith, the program code executable by a processor to perform a method comprising:
causing a plurality of display devices to each display a unique identifier;
capturing an image that includes the plurality of display devices; and
determining a location of one or more of the plurality of display devices using the image.

2. The computer program product of claim 1, further comprising causing one or more of the plurality of display devices to display a portion of an overall display image corresponding to the position of each of the one or more of the plurality of display devices.

3. The computer program product of claim 1, wherein determining the location of one or more of the plurality of display devices further employs location information obtained from one or more of the plurality of display devices.

4. The computer program product of claim 3, wherein location information comprises latitude information and longitude information.

5. The computer program product of claim 3, wherein location information identifies a location on a two-dimensional grid.

6. The computer program product of claim 3, wherein location information comprises location information in three-dimensional space.

7. The computer program product of claim 3, wherein location information comprises seat location information.

8. The computer program product of claim 1, further comprising registering each of the plurality of display devices.

9. The computer program product of claim 1, further comprising determining if any of the plurality of display devices have moved using at least one additional image of the plurality of display devices.

10. The computer program product of claim 9, further comprising determining a new location for each of one or more of the plurality of display devices using the at least one additional image.

11. The computer program product of claim 10, further comprising causing one or more of the plurality of display devices to display a portion of an overall display image corresponding to the new location for each of the one or more of the plurality of display devices.

12. The computer program product of claim 1, wherein the unique identifier comprises at least one or more of the following:
a bar code;
an image-based bar code;
a visual pattern;
a temporal pattern;
an alphanumeric string; and
one or more images.

13. The computer program product of claim 1, wherein the unique identifier has at least one registration mark, the registration mark comprises one or more of the following:
a target;
a one-dimensional bar code; and
a two-dimensional bar code.

14. The computer program product of claim 1, wherein the unique identifier comprises attenuating a portion of the overall display image.

15. The computer program product of claim 1, wherein the unique identifier comprises a binary pattern.

16. The computer program product of claim 1, wherein the unique identifier comprises one or more of the following:
a registration mark at one corner of a display;
a registration mark at another corner of the display; and
a registration mark at each corner of a display.

17. The computer program product of claim 1, further including communicating with one or more of the plurality of display devices over a communications network, the communications network comprising one of the following:
a wireless connection;
a cellular data network;
a wireless local area network;
a wireless personal area network;
a wireless mesh network;
a line-of-sight wireless connection; and
a combination of the above.

18. The computer program product of claim 1, wherein capturing the image comprises one or more of the following:
a camera;
a rangefinding device;
a thermographic imaging device; and
a stereoscopic camera.

19. The computer program product of claim 1, further including obtaining display configuration information about at least one of the plurality of display devices.

20. The computer program product of claim 1, where the causing a plurality of display devices to each display a unique identifier further includes the unique identifier being spread over one or more of the plurality of display devices.
